(19) United States
(12) Patent Application Publication
(10) Pub. No.: US 2025/0390207 A1
(43) Pub. Date: Dec. 25, 2025

(54) Augmented Reality Control System and Method of Use Thereof

(71) Applicant: Arun Kurian, New Milford, NJ (US)

(72) Inventor: Arun Kurian, New Milford, NJ (US)

(21) Appl. No.: 18/748,859

(22) Filed: Jun. 20, 2024

(51) Int. Cl. G06F 3/04847; G06F 3/01; G06F 3/04815

(52) U.S. Cl. CPC G06F 3/04847; G06F 3/017; G06F 3/04815

(57) ABSTRACT

An augmented reality system, including an electronic device which has variation of at least one of velocity, brightness, and electric current flow, and an augmented reality switch operable to vary one of the at least one of velocity, brightness, and electric current flow in the electronic device. The augmented reality switch appears in an augmented reality display system at a location designated for the switch. Selection of the switch causes a slider to be displayed on the augmented reality display. A motion detection system receives input from the augmented reality display system. Detection of motion applied to the augmented reality switch causes the variation of the at least one of velocity, brightness, and electric current flow in the electronic device.

### FIELD OF THE DISCLOSED TECHNOLOGY

The disclosed technology relates to systems and methods for controlling electronic devices. More specifically, the disclosed technology relates to an augmented reality control system for controlling electronic devices using a virtual display, and to a method of use thereof.

### BACKGROUND OF THE DISCLOSED TECHNOLOGY

Augmented reality (AR) is an immersive technology that overlays digital information and visualizations onto the real-world environment. Unlike virtual reality which creates an entirely synthetic world, AR enhances and augments the physical world around us. AR applications work by rendering computer-generated imagery, text, and other multimedia content on top of live camera feeds or smart glasses' viewfinders. This blended view of digital and physical realities allows users to interact with virtual elements while still being present in their actual surroundings.

One of the key use cases for AR is enabling new forms of interaction with physical objects and devices. Through AR interfaces, users can view additional contextual information about real-world items, access instructions, and interactive responses by simply looking at the target object. For example, someone repairing an appliance could use an AR app to identify components, follow guided repair steps, and visualize diagram overlays. In industrial settings, AR can overlay maintenance data, IoT sensor readings, or procedural, guides directly onto machinery.

AR systems use advanced computer vision, depth tracking, and spatial mapping capabilities to accurately anchor and integrate virtual content with physical environments and objects. This spatial awareness allows for convincing occlusion effects where digital elements can be obscured by real objects in the foreground. Hand gesture recognition, gaze tracking, and controller input enable users to naturally interact with and manipulate these virtual AR elements overlaid onto the real world. As augmented reality technologies mature, interacting with our surroundings through immersive digital enhancements and interfaces will likely become increasingly ubiquitous.

However, existing AR systems require a device to be within a field of view of a visualizing system in order to provide virtual content relating to that device, or the ability to control that device.

### SUMMARY OF THE DISCLOSED TECHNOLOGY

In accordance with embodiments of the disclosed technology, there is provided an augmented reality control system. The augmented reality control system includes an augmented reality device including a display. A plurality of physical devices, each having at least one electronic control sensor and/or actuator, and a plurality of identifying codes, each of which is mapped to one of the electronic control sensor and/or the actuator associated with the plurality of physical devices. Each of the electronic control sensors and/or the actuators are associated with at least one identifying code of the plurality of identifying codes.

The system further includes a plurality of physical locations, each at assigned coordinates on a real-world surface. Each physical location of the plurality of physical locations includes an augmented reality switch of a plurality of augmented reality switches, each augmented reality switch being associated with a specific identifying code of the plurality of identifying codes.

Each augmented reality switch appears at a respective physical location of the plurality of physical locations when viewed using the augmented reality device, when the physical location is in view of and is displayed on the display. The electronic control sensor and/or the actuator of a specific physical device of the plurality of physical devices causes motion or a change to at least a part of the specific physical device when an associated augmented reality switch, associated with a specific identifying code mapped to the electronic control sensor and/or the actuator of the specific physical device, is manipulated virtually.

In some embodiments, a physical location of the associated augmented reality switch is at coordinates corresponding to a surface of the specific physical device.

In some embodiments, a physical location of the associated augmented reality switch is at coordinates corresponding to a location where the specific physical device is out of sight of the display.

In some embodiments, virtual manipulation of the associated augmented reality switch results in switching between a plurality of electrical current levels, the plurality of electrical current levels each lacking a physical reality switch for the specific physical device.

In some embodiments, virtual manipulation of the associated augmented reality switch results in switching between a plurality of volume levels, the plurality of volume levels each lacking a physical reality switch for the specific physical device.

In some embodiments, virtual manipulation of the associated augmented reality switch results in switching between a plurality of velocity levels, the plurality of velocity levels each lacking a physical reality switch for the specific physical device.

In some embodiments, a specific hand gesture controls a sliding scale state of at least one augmented reality switch of the plurality of augmented switches.

In accordance with embodiments of the disclosed technology, there is provided an augmented reality system, including an electronic device which has variation of at least one of velocity, brightness, and electric current flow, and an augmented reality switch operable to vary one of the at least one of velocity, brightness, and electric current flow in the electronic device.

The system further includes an augmented reality display system, the augmented reality switch appearing in the augmented reality display system at a location designated for the switch. Selection of the switch causes a slider to be displayed on the augmented reality display.

The system further includes a motion detection system receiving input from the augmented reality display system. A detection of motion applied to the augmented reality switch causes the variation of the at least one of velocity, brightness, and electric current flow in the electronic device.

In some embodiments, the augmented reality switch is shown in a display of the augmented reality display system at a physical location associated with the electronic device.

In some embodiments, the augmented reality switch is shown in a display of the augmented reality display system at a physical location at which the electronic device is out of a field of view of the augmented reality display system.

In some embodiments, the slider is displayed on the augmented reality display within arms-reach of a user operating the augmented reality display system.

Any device or step to a method described in this disclosure can comprise or consist of that which it is a part of, or the parts which make up the device or step. The term “and/or” is inclusive of the items which it joins linguistically and each item by itself. “Substantially” is defined as at least 95% of the term being described and/or “within a tolerance level known in the art and/or within 5% thereof. Any device or aspect of a device or method described herein can be read as “comprising” or “consisting” thereof.

### BRIEF DESCRIPTION OF THE DRAWINGS

FIG. 1 shows a schematic block diagram of an augmented reality control system according to embodiments of the disclosed technology.

FIG. 2 shows a schematic illustration of implementation of the augmented reality control system in a gym setting, according to an embodiment of the present disclosed technology.

FIGS. 3A, 3B, and 3C show schematic illustrations of use of the augmented reality control system in the gym setting of FIG. 2, according to embodiments of the disclosed technology.

FIG. 4 shows a schematic illustration of implementation of the augmented reality control system in a conveyor or factory setting, according to an embodiment of the present disclosed technology.

FIG. 5 shows a schematic illustration of use of the augmented reality control system in the conveyor or factory setting of FIG. 4, according to embodiments of the disclosed technology.

FIG. 6 shows a schematic illustration of implementation of the augmented reality control system in a restaurant setting, according to an embodiment of the present disclosed technology.

### DETAILED DESCRIPTION OF EMBODIMENTS OF THE DISCLOSED TECHNOLOGY

The disclosed technology provides an augmented reality control system and method, enabling a user to control one or more electronic devices via an augmented reality device. Specifically, the user can virtually manipulate an augmented reality switch which is associated with a specific controller of a specific electronic device, thereby to manipulate an aspect of the electronic device. For example, the user may manipulate or control the volume, velocity, or electrical current of the electronic device by virtually manipulating the associated augmented reality switch.

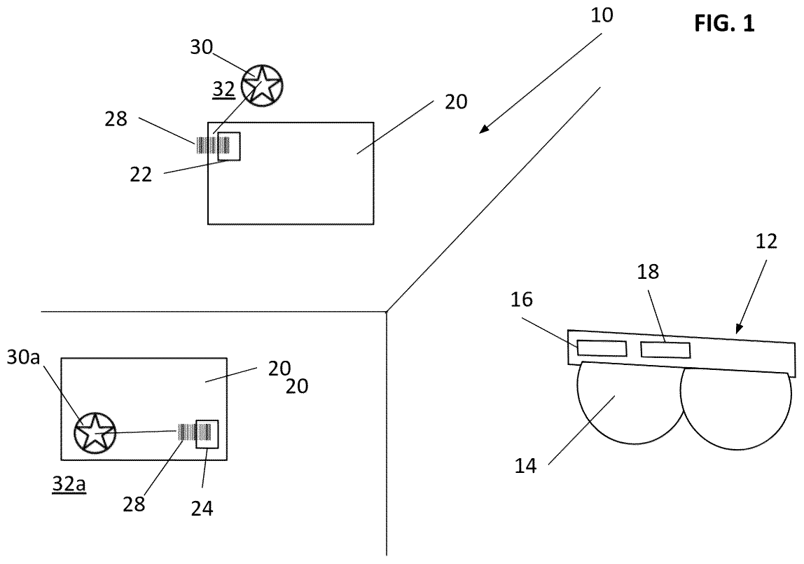

Reference is now made to FIG. 1, which shows a schematic block diagram of an augmented reality control system 10 according to embodiments of the disclosed technology.

System 10 includes an augmented reality device 12 including a display 14. The augmented reality device is adapted to be used by a user, and may include, for example, augmented reality glasses or goggles. In some embodiments, the augmented reality device 12 may further include a motion detection system 16, functionally associated with display 14 and adapted to receive input therefrom. The motion detection system 16 may be able to detect motion applied within a field of view of display 14, such that a controller 18 of device 12 can interpret the motion as a specific instruction to be carried out.

System 10 further includes a plurality of physical devices 20, each including at least one electronic control sensor 22 and/or at least one actuator 24. For example, physical devices 20 may include illumination devices such as lamps, moving devices such as conveyors or fans, media devices such as screens, speakers, televisions, radios, and the like. The electronic control sensors 22 and/or the actuators 24 may control activation or de-activation of the device (e.g., an on/off switch), volume of the device, display of the device (e.g., brightness of a display, color of a display, and the like), velocity of the device (e.g., velocity of motion of a fan or conveyor), temperature of the device (e.g., a temperature setting of an electric stove or oven), a timing component of the device (e.g., a clock or timer of an electric stove or oven), electrical current provided to the device, and the like.

Identifying codes 28 are each mapped to one of sensors 22 or actuator 24, such that each sensor or actuator is associated with at least one code 28.

Augmented reality switches 30 are associated with a plurality of physical, real-world location 32, each at specific coordinates on a real-world surface. Each such augmented reality switch 30 at a real-world location is associated with a specific identifying code 28, which, as mentioned above, is mapped to a sensor 22 or to an actuator 24. For example, one switch may be disposed on the ceiling of a room, and another may be disposed on a wall of a room.

In some embodiments, the real-world location of switch 30 mapped to a sensor 22 or an actuator 24 is at coordinates corresponding to, or located on, a surface of a physical device 20 including those that sensor or actuator.

In some embodiments, the real-world location of switch 30 mapped to a sensor 22 or an actuator 24 is at coordinates corresponding to, or located on, a surface that is not part of the physical device 20 including those that sensor or actuator. In some embodiments, the physical device may not even be in the line of sight or in the field of view of the augmented reality device 14 when the real-world location of switch 30 is within the field of view.

When the user views a specific real-world location 32a, the corresponding augmented reality switch 30a is virtually displayed on display 14. For example, the switch may be displayed as a slider, a push button, or a color selector. Virtual user manipulation of the virtually displayed switch is identified, by the identifying code mapped to that switch, as interaction with the sensor 22 or actuator 24, and results in motion of, or a change to, the physical device, as if the sensor or actuator were directly, or physically, operated upon by the user.

In some embodiments, the virtual manipulation of switch 30a may enable selection of one of multiple levels of electrical current, even if the sensor 22 or actuator 24 with which that switch is associated lack the ability to control multiple levels of electrical current (e.g., it is a simple on/off actuator).

In some embodiments, the virtual manipulation of switch 30a may enable selection of one of multiple volume or velocity levels, even if the sensor 22 or actuator 24 with which that switch is associated lack the ability to control multiple volume or velocity levels.

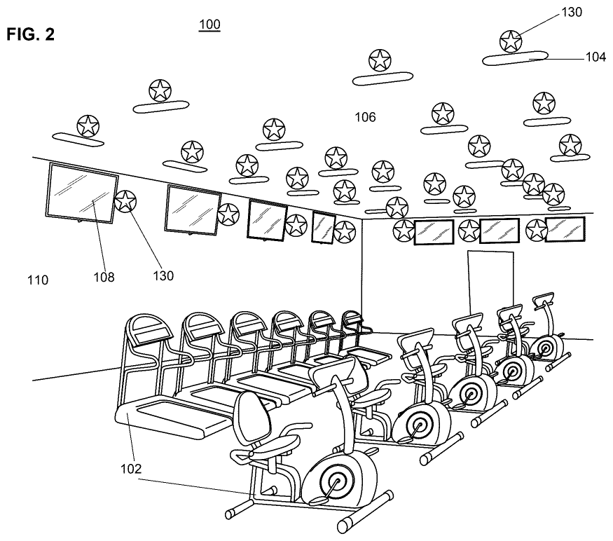

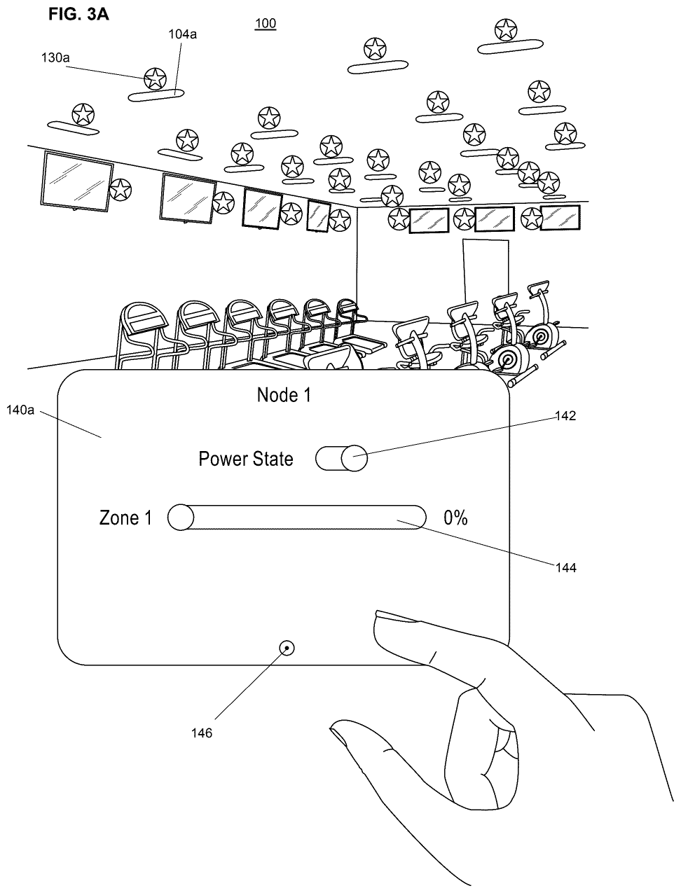

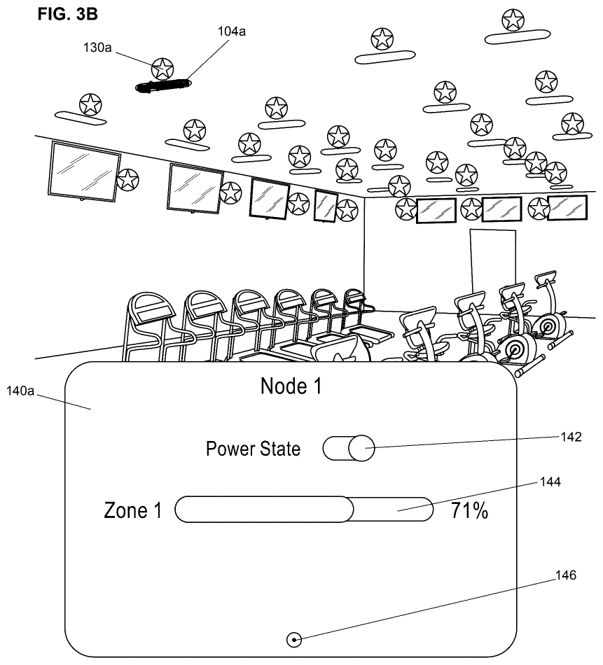

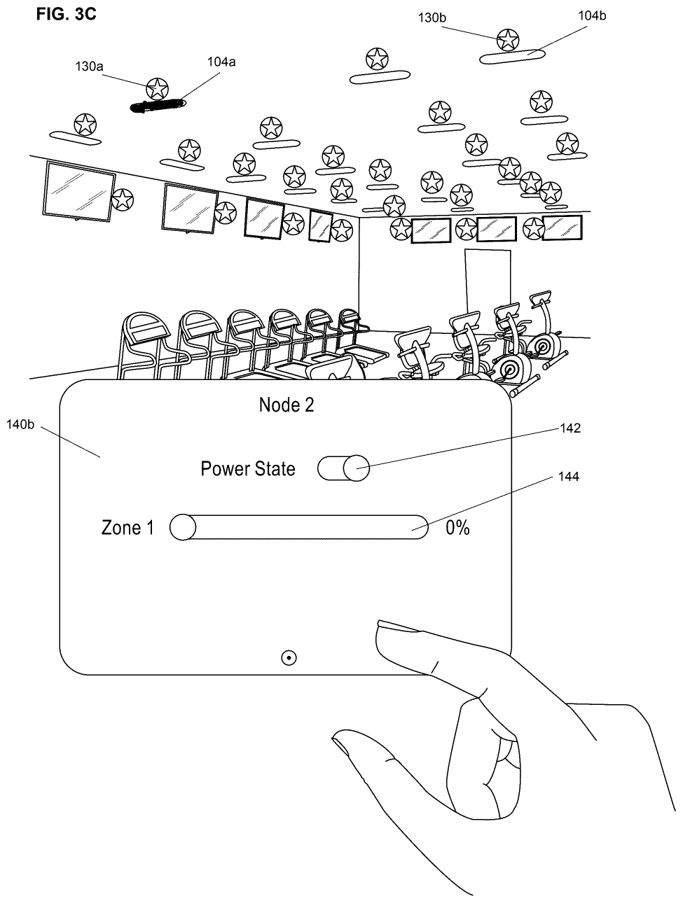

Reference is now made to FIG. 2, which shows a schematic illustration of implementation of the augmented reality control system in a gym setting, according to an embodiment of the present disclosed technology, and to FIGS. 3A, 3B, and 3C, which show schematic illustrations of use of the augmented reality control system in the gym setting of FIG. 2.

As seen in FIG. 2, a gym 100 includes a plurality of exercise machines 102. A plurality of light-fixtures 104 are disposed on a ceiling 106 of the gym, and a plurality of display screens 108 are disposed on walls 110 of the gym. Each of light-fixtures 104 is associated with one or more light actuators (e.g., light switches) (not explicitly shown), for turning that light-fixture on or off. Each display screen 108 is associated with one or more control buttons (not explicitly shown), such as an on/off button, a volume up/down button, a channel up/down button, and the like.

In accordance with the disclosed technology, multiple augmented reality switches 130, here illustrated as stars circumscribed by circles, are disposed on a surface of ceiling 106 or of a wall 110 of the gym. Each of augmented reality switches 130 is adjacent one of light-fixtures 104 or displays 108, and is associated with an identifying code mapped to an actuator or button of the adjacent light-fixture or display.

FIGS. 3A, 3B, and 3C illustrate what the user sees, when using an augmented reality device (not explicitly shown) to interact with light-fixtures 104 or displays 108.

In FIG. 3A, the user has selected a specific augmented reality switch 130a, also termed node 1, associated with a specific light-fixture 104a. This has caused a menu 140a, or interaction box, to pop up in the user's line-of-sight. Menu 140a includes an on/off switch 142 associated with the power state of light-fixture 104a, and an intensity slider 144 associated with the intensity of the light emanating from the light-fixture. The user may interact with menu 140a using their hand, for example by virtually tapping on the displayed switch to move it between the on and off power states, or by virtually pulling the slider to increase the “light percentage” emanating from light-fixture 104a. Menu 104a may further include an exit button 146, which, when virtually pressed by the user, closes the menu 104a or moves to a previous menu level.

More specifically, a motion detection system of the augmented reality device (see elements 12 and 16 of FIG. 1) identifies detects a motion applied to menu 140a within a field of view, or within a display (element 14 of FIG. 1) of the device. A controller of the augmented reality device (18 in FIG. 1) interprets the detected motion as interaction with switch 142 or slider 144, and initiates a corresponding change in the light-fixture 104a. In some embodiments, the motion detection system is adapted to detect a specific hand gesture as virtual sliding of slider 144. For example, a pinching gesture (similar to that made to zoom out of an image on a smartphone display) may be interpreted as moving slider 144 to the left (to dim light-fixture 104a), and a spreading or zooming out gesture (similar to that made to zoom in on an image on a smartphone display), may be interpreted as moving slider 144 to the right, to increase the amount of light emanating from light-fixture 104a.

Turning to FIG. 3B, it is seen that the user has interacted with slider 144 to move the slider from 0% illumination (as shown in FIG. 3A) to 71% illumination, and that correspondingly, light is emanating from light fixture 104a.

In FIG. 3C, the user has selected a different augmented reality switch 130b, also termed node 2, associated with a second light-fixture 104b. This has caused a menu 140b, similar to menu 140a, to pop up in the user's line-of-sight. As seen, the user is spreading his fingers to move slider 144 of menu 140b to the right, causing more light to emanate from light-fixture 104b.

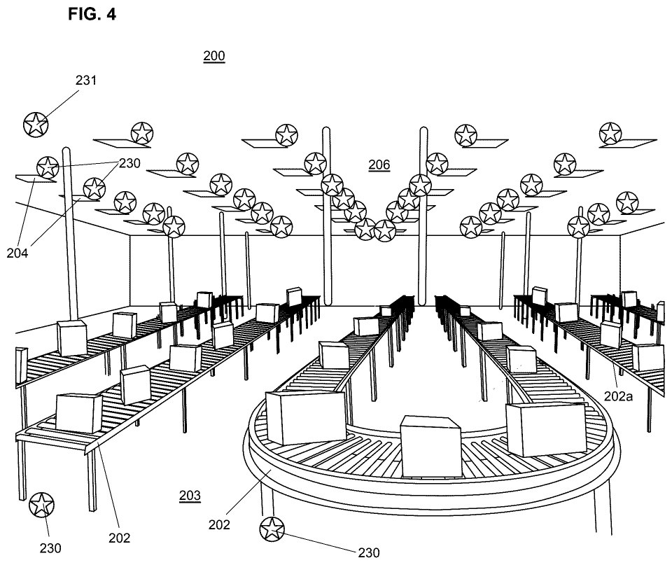

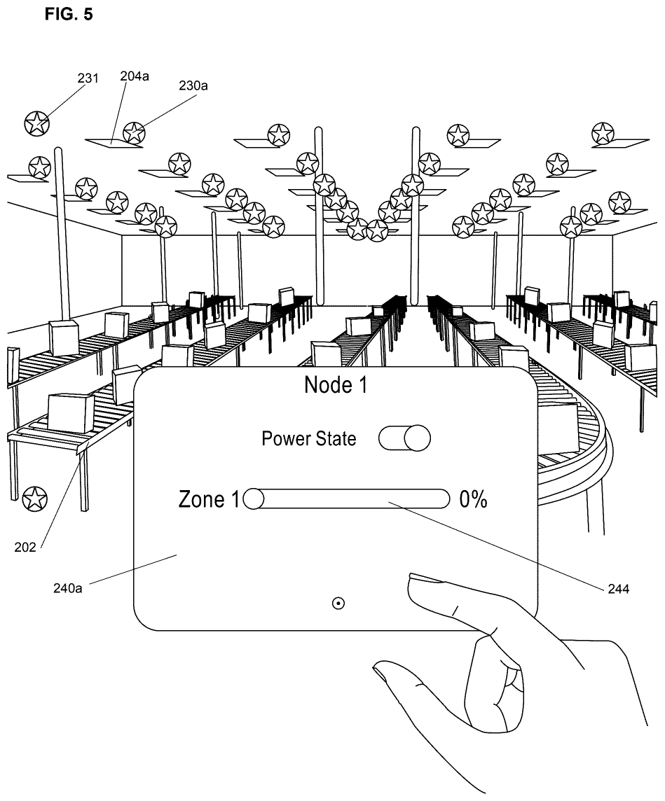

Reference is now made to FIG. 4, which shows a schematic illustration of implementation of the augmented reality control system in a conveyor or factory setting, according to an embodiment of the present disclosed technology, and to FIG. 5, which is a schematic illustration of use of the augmented reality control system in the conveyor or factory setting.

As seen in FIG. 4, a factory 200 includes a plurality of conveyors 202, disposed on a floor 203 of the factory. A plurality of light-fixtures 204 are disposed on a ceiling 206 of the factory. Each of light-fixtures 204 is associated with one or more light actuators (e.g., light switches) (not explicitly shown), for turning that light-fixture on or off. Each conveyor 202 is associated with one or more control buttons (not explicitly shown), such as an on/off button, a velocity up/down button, and the like.

In accordance with the disclosed technology, multiple augmented reality switches 230, here illustrated as stars circumscribed by circles, are disposed on a surface of ceiling 206, of floor 203, or of conveyors 202, within the factory. Each of augmented reality switches 230 is adjacent one of conveyors 202 or light-fixtures 204, and is associated with an identifying code mapped to an actuator or button of the adjacent conveyor or light-fixture. However, in some embodiments, an augmented reality switch 231 may be associated with a device (e.g., a light-fixture or a conveyor) which is not adjacent thereto. For example, augmented reality switch 231 may be associated with conveyor 202a, on the other side of the room. In such embodiments, the user may use augmented reality switch 231 to manipulate conveyor 202a, while the conveyor is not visible to the user.

FIG. 5 illustrates what the user sees, when using an augmented reality device (not explicitly shown) to interact with conveyors 202 or light-fixtures 204.

In FIG. 5, the user has selected a specific augmented reality switch 230a, also termed node 1, associated with a specific light-fixture 204a. This has caused a menu 240a, similar to menu 140a, described hereinabove with respect to FIG. 3A, to pop up in the user's line-of-sight. As seen, the user is spreading his fingers to move slider 244 of menu 240a to the right, causing more light to emanate from light-fixture 204a.

It is to be appreciated that if the user were to select a node associated with one of conveyors 202, the pop-up menu may include a slider to control the velocity of the conveyor, which slider may be operated by a suitable hand gesture, in a similar manner to that described.

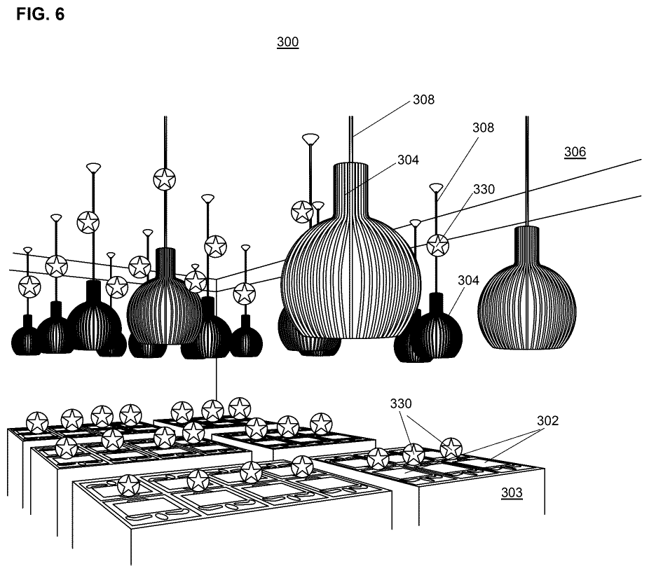

Reference is now made to FIG. 6, which shows a schematic illustration of implementation of the augmented reality control system in a commercial restaurant setting, according to an embodiment of the present disclosed technology.

As seen in FIG. 6, a commercial kitchen 300 includes a plurality of electric stove tops 302, disposed on surfaces of cabinets 303 within the kitchen. A plurality of light-fixtures 304 extend downwardly from a ceiling 306 of the kitchen, along wires 308. Each of light-fixtures 304 is associated with one or more light actuators (e.g., light switches) (not explicitly shown), for turning that light-fixture on or off. Each stove top 302 is associated with one or more control buttons (not explicitly shown), such as an on/off button, a heat up/down button, a burner selection button, and the like.

In accordance with the disclosed technology, multiple augmented reality switches 330, here illustrated as stars circumscribed by circles, are disposed on surfaces of wires 308 and of stove tops 302, within the kitchen. Each of augmented reality switches 330 is associated with an identifying code mapped to an actuator or button of an adjacent stove top or light-fixture.

Augmented reality switches 330 may be used to control illumination emanating from light fixtures 304 and/or operation of stove tops 302, substantially as described above with respect to FIGS. 3A to 3C and 5. For example, a pop-up menu associated with a stove top 302 may include a selector for selection of a specific burner to activate or turn off, and/or a slider for controlling the intensity of heat emanating from a selected burner or from each burner.

The present technology can be carried out with one or more of the embodiments described. The drawings show embodiments with the understanding that the present description is to be considered an exemplification of the principles and is not intended to be exhaustive or to limit the disclosure to the details of construction. The arrangements of the components are set forth in the following description or illustrated in the drawings.

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods, systems, and devices described herein-above are also contemplated and within the scope of the disclosed technology.

I claim:

1. An augmented reality control system, comprising:
an augmented reality device including a display;
a plurality of physical devices, each with at least one electronic control sensor and/or actuator;
a plurality of identifying codes, each of which is mapped to one of said electronic control sensor and/or said actuator associated with said plurality of physical devices, such that each of said electronic control sensors and/or said actuators are associated with at least one identifying code of said plurality of identifying codes; and
a plurality of physical locations, each at assigned coordinates on a real-world surface, each physical location of said plurality of physical locations comprising an augmented reality switch of a plurality of augmented reality switches, each said augmented reality switch being associated with a specific identifying code of said plurality of identifying codes;
wherein each said augmented reality switch appears at a respective physical location of said plurality of physical locations when viewed using said augmented reality device, when said physical location is in view of and is displayed on said display, and
wherein said electronic control sensor and/or said actuator of a specific physical device of said plurality of physical devices causes motion or a change to at least a part of said specific physical device when an associated augmented reality switch associated with a specific identifying code mapped to said electronic control sensor and/or said actuator of said specific physical device is manipulated virtually.

2. The augmented reality control system of claim 1, wherein a physical location of said associated augmented reality switch is at coordinates corresponding to a surface of said specific physical device.

3. The augmented reality control system of claim 1, wherein a physical location of said associated augmented reality switch is at coordinates corresponding to a location where said specific physical device is out of sight of said display.

4. The augmented reality control system of claim 1, wherein virtual manipulation of said associated augmented reality switch results in switching between a plurality of electrical current levels, said plurality of electrical current levels each lacking a physical reality switch for said specific physical device.

5. The augmented reality control system of claim 1, wherein virtual manipulation of said associated augmented reality switch results in switching between a plurality of volume levels, said plurality of volume levels each lacking a physical reality switch for said specific physical device.

6. The augmented reality control system of claim 1, wherein virtual manipulation of said associated augmented reality switch results in switching between a plurality of velocity levels, said plurality of velocity levels each lacking a physical reality switch for said specific physical device.

7. The augmented reality control system of claim 1, wherein a specific hand gesture controls a sliding scale state of at least one augmented reality switch of said plurality of augmented switches.

8. An augmented reality system, comprising:
an electronic device which has variation of at least one of velocity, brightness, and electric current flow;
an augmented reality switch operable to vary one of said at least one of velocity, brightness, and electric current flow in said electronic device;
an augmented reality display system, said augmented reality switch appearing in said augmented reality display system at a location designated for said switch, wherein selection of said switch causes a slider to be displayed on said augmented reality display;
a motion detection system receiving input from said augmented reality display system, wherein a detection of motion applied to said augmented reality switch causes said variation of said at least one of velocity, brightness, and electric current flow in said electronic device.

9. The augmented reality system of claim 8, wherein said augmented reality switch is shown in a display of said augmented reality display system at a physical location associated with said electronic device.

10. The augmented reality system of claim 8, wherein said augmented reality switch is shown in a display of said augmented reality display system at a physical location at which said electronic device is out of a field of view of said augmented reality display system.

11. The augmented reality system of claim 8, wherein said slider is displayed on said augmented reality display within arms-reach of a user operating the augmented reality display system.
